(19) United States
(12) Patent Application Publication
(10) Pub. No.: US 2012/0019612 A1
(43) Pub. Date: Jan. 26, 2012

(54) NON VIRTUAL 3D VIDEO/PHOTO GENERATOR RENDERING RELATIVE PHYSICAL PROPORTIONS OF IMAGE IN DISPLAY MEDIUM (AND HENCE ALSO OF THE DISPLAY MEDIUM ITSELF) THE SAME AS THE RELATIVE PROPORTIONS AT THE ORIGINAL REAL LIFE LOCATION

(76) Inventor: Spandan Choudury, Thane (IN)

(21) Appl. No.: 12/965,931

(22) Filed: Dec. 13, 2010

Related U.S. Application Data
(63) Continuation of application No. PCT/IB2009/052404, filed on Jun. 7, 2009.
(60) Provisional application No. 61/061,108, filed on Jun. 12, 2008.

(30) Foreign Application Priority Data
Jun. 7, 2009 (IB) PCT/IB2009/052404

(51) Int. Cl. H04N 13/04

(52) U.S. Cl. 348/36; 348/E13.026

(57) ABSTRACT

This device replicates real life as non-virtual 3D photos or non-virtual 3D videos, in the sense that the 3D videos or 3D photos are not generated to be displayed in, or on, medium whose dimensions are proportionally different from those at the original actual real life location (for example, the images would not be displayed on a flat screen and artificially made to look 3D, etc). Instead, the photos or videos would be displayed in a three dimensional medium whose relative proportions would be the same as those at the original real life location. Any count of different viewer(s) at different locations relative to the display medium would be able to simultaneously view the generated video or photo from absolutely ANY different angles, as they would at the original real life location. The viewer(s) would be able to physically walk around or over or under the physical display medium, and be able to see the non-virtual-3D video/photo displayed inside it as having the exact same actual physical proportions as those at the original location from those same angles. While the physical dimensions of the displayed non-virtual-3D video/photo (and hence also of the display medium itself) could be anything, the relative proportions of those dimensions of the non-virtual-3D video/photo (and hence also of the display medium) will be the same as those at the original location. Optionally the relative proportions of the dimensions of the non-virtual-3D video/photo can also be artificially altered if the viewer chooses.

### CROSS REFERENCE TO RELATED APPLICATION

This continuation patent application claims the benefit of PCT International Application No. PCT/IB32009/052404 filed with RO/IB on 7 Jun. 2009 which is incorporated herein by reference in its entirety. (The aforementioned PCT International Application No. PCT/IB2009/052404 already claims the benefit of United States Provisional Patent. Application No. 61061108, filed on 12 Jun. 2008 which is incorporated therein by reference in its entirety).

### FIELD OF INVENTION

The fields of invention are primarily 3D optics, algorithms, hardware machine code optimization and 3D display hardware.

### BACKGROUND OF INVENTION

Most 3D video consumed in the world today are generated for 2D screens. While a 2D screen has its benefits, it limits the “reality” perspective of the viewers. That includes, but aren't limited to, typical holograms.

There are a very few 3D mediums of 3D display available today, but they either don't display real time video streams or display in poor video quality or both.

This invention renders relatively good quality 3D video display, real time, in an actual 3D display medium. It would be possible for any count of people to simultaneously see the video from any direction, real time, at a reasonably high quality of viewing. One could walk around the 3D display exactly as one would walk around the corresponding original objects.

### SUMMARY OF INVENTION

Streaming video data collected by a finite set of cameras at different angles would be processed and transmitted to the viewer for display as a 3D video stream in a 3D display medium. Various algorithms and display mediums apply.

The key components of the invention are
1. At the viewer's end—a 3D display medium (including computing units that would be able to process and project into the 3D display medium the streaming data received from the video originator's end).
2. At the video originator's end
   a. Multiple cameras, ordinarily at least two on each viewing plane.
   b. Microprocessors (including when necessary adequate computers) running algorithms processing video information collected from the cameras, to compute the 3D coordinates (in particular inclusive of computed “depth” data), interpolated 3D coordinates and the corresponding interpolated color data.

### SUMMARY OF DIAGRAMS

FIG. 1

This depicts a depth computation algorithm example.

FIG. 2

An example of angle computations for the depth computation algorithm is presented.

FIG. 3

Shown are example variants in the shape of the 3D viewing box at the viewer's side.

The viewing space at the viewer's end can be of any shape, and can all be manifested for compatibility to the same unchanged camera group's setup at the video stream originator's end. The recommended best setup at the video stream originator's end is a rectangular parallelepiped viewing plane camera layout configuration specifically elaborated in this patent application.

FIG. 4

An example of the camera configuration at the video stream originator's end is shown.

In this example, there are 2 cameras on each of the vertical four of the six viewing planes, and on the top horizontal viewing plane. None of the cameras on vertical Viewing Planes 1-4 are on the same horizontal plane as any of the other cameras, and the cameras on horizontal Viewing Plane 5 are on different vertical planes too—that relative positioning, however, is not mandatory and the cameras at all the vertical viewing planes could all be placed on the same horizontal plane, and vice versa. The count of cameras on each plane is recommended to be 2 or more depending on the surface area of the viewing plane and on the degree of precision in depth and images sought. It is possible to even have just one camera on a viewing plane, but that would degrade the manifestation at the viewer's end of the combination of correct depth and corresponding image portion details.

FIG. 5

Presented in this figure is an example of the overall operation of the invention.

For descriptive legends on one or more of the figures, see subsection “Descriptive legends on figures” towards the end of the section “DESCRIPTION OF EMBODIMENTS OF INVENTION”

### DESCRIPTION OF EMBODIMENTS OF INVENTION

The invention enables real time 3D display in a 3D display medium. Of course static 3D video frames or 3D photos can also be displayed.

The key components of the invention are—
1. At the viewer's end—a 3D display medium (including computing units that would be able to process and project into the 3D display medium the streaming data received from the video originator's end).
2. At the video originator's end
   a. Multiple cameras, ordinarily at least two on each viewing plane.
   b. Microprocessors (including when necessary adequate computers) running algorithms processing video information collected from the cameras, to compute the 3D coordinates (in particular inclusive of computed “depth” data), interpolated 3D coordinates and the corresponding interpolated color data.

The actual object at the originator's end is viewed by (preferably, albeit not mandatorily) at least two cameras from each plane of view for a particular video stream. Of course, typically there are 6 primary planes of view for any object—exactly as there are six surfaces in a cube or in a rectangular parallelepiped. However, it is possible to indefinitely increase that count beyond six—albeit that would ordinarily not be necessary and yet not compromise video quality.

Therefore if it is chosen that a particular video stream would be transmitted for viewing from say 4 directions (i.e. 4 viewing planes), then there would preferably be at least 8 cameras—two on each viewing plane—looking at the real objects. Depending on the surface area of any viewing plane, the count of cameras on the viewing plane could be increased.

Video information from each camera pair on a viewing plane would be processed by the microprocessor(s) to identify the exact color and 3D coordinates of visible (from that viewing plane) portions of objects as viewed from that viewing plane. This would obviously exclude color and 3D spatial coordinate information on those portions of the same objects that are not visible from that viewing plane (and are only visible from one or more of the other viewing planes, if at all).

Then equivalent information is collected from cameras on all the other viewing planes and processed. Such equivalent information would include visible (from those corresponding viewing planes) portions of objects that are common to more than one viewing plane (yet those common objects would of course not entirely be visible from any one viewing plane), and objects that might each be visible (only as a portion) from a total of only one viewing plane.

Then the views will be combined by the microprocessor(s) to determine the exact “3D surface” contour of the real world, including of semi-transparent material, and map color information from multiple angles (from the multiple cameras on all the chosen viewing planes) on each 3D computing pixel (i.e. 3D viewing pixel) of the contour. Color information on any computing pixel's (i.e. viewing pixel's) surface that is not visible (obviously, for example, when a particular range of angles of views on portions of an object are not directly visible from a particular viewing plane's cameras) is not projected (essentially projecting a uniformly color absorptive “black”) for those surfaces for those pixels. The end result is a complete 3D contour having the same colors as the original.

That entire contour would be refreshed real time, resulting in a real time 3D display.

Note—

For purposes of depth and color tagging in the context of this patent application there are two categories of pixels considered—the logical pixel and the hardware display medium's pixel. The logical pixel, also termed in this patent application as the “computing pixel”, is the smallest picture unit for purposes of computation and tagging. The dimensions of the computing pixel are typically greater than the dimensions of the hardware display medium's pixel in the viewing box. Typically, several hardware pixels would comprise a computing pixel. The component hierarchy for purposes of this patent application is

Object→Object portion→Computing pixel→Viewing pixel→Hardware display medium's pixel

### Technical Details

The key technical considerations in the invention are

At the video originator's end—

C1. How to accurately determine 3D coordinate information on portions of an object visible from any one viewing plane that the object is visible from

C2. How to merge the above information with corresponding 3D coordinate information on the (other) portions of that same object that are visible from other viewing planes

C3. How to process all information for real time transmission at the lowest possible bandwidth

At the viewer's end—

C4. How to develop a 3D medium for 3D display that acceptably accurately represents real time streaming video information received from the video originator's end

The solutions have been as follows (designated Solution S1 for Consideration C1 and so forth).

### S1. Determining 3D Coordinate Information On Portions of An Object Visible From Any One Viewing Plane

Consider the example in FIG. 1, where an object portion is viewed by two cameras on a vertical viewing plane, and the two cameras are also on the same horizontal plane for an easier explanation of the core of this solution. The distance between the cameras is “d”, a known value. The depth “h” of the object portion computing pixel is not known and needs to be determined. The angles “α” and “β” are known, being the angle between each corresponding camera and the object portion's computing pixel (i.e. viewing pixel). Because the exact location of the object portion is yet unknown, “y” is not known as well.

h=y·tan(α)=(y+d)·tan(β)

→y=d·tan(β)/{tan(α)−tan(β)}

→h=d·tan(β)·tan(α)/{tan(α)−tan(β)}

→h=d·tan(β)/{1−tan(β)/tan(α)}

Accordingly, the precise depth of the object portion computing pixel (i.e. viewing pixel) is determined.

As to how the angles α and β are to be determined, the following is one of several optional answers—

See FIG. 2. Consider line S_{f}P_{f} in any image frame of video stream being captured by Camera 1, where the shortest distance (length of CP) of the corresponding actual line SP from the viewing plane of Camera 1 is known. Consider T_{f} as the location of the object portion computing pixel within a 2D image frame taken from Camera 1. N_{f} is the point on S_{f}P_{f} that exactly overlays onto T_{f} in the image frame. Since the actual distances NP and PC are known, the angle between lines NC and CP is known (being tan⁻¹ (length of NP/length of PC)). That would be the same angle as that between T_{f}C and CD, even though that angle (between T_{f}C and CD) cannot be directly computed as the length of DC is unknown.

Therefore, α=n/2−tan⁻¹ (length of NP/length of PC)

Accordingly, based on the length of N_{f}P_{f} in the image frame the angle α can be computed as calibrated from the relative lengths of NP and PC.

The angle β will be computed the same way.

Therefore, the actual physical depth of the object portion computing pixel location is calculated, and the same can be done for all object portions visible from the two cameras on that viewing plane.

A number of other equivalent, self evident algorithms in extension of the above algorithm and/or otherwise are optionally possible, not detailed herein and are all included in the scope of this invention only to the extent that they constitute part of the complete invention, and are not included in the scope of this invention by themselves alone.

Note—If the object portion whose depth is to be determined is located at a horizontal plane below or above the horizontal plane of any of the cameras on the vertical viewing plane then the depth computation process will essentially be similar to Solution S1 except that either Solution S1 computations (above) will be first proceeded with towards determining the distance at that inclined angle and then the actual horizontal distance from the viewing plane computed by calculating the horizontal component of that inclined distance, or alternatively the respective horizontal computations need to be computed first and then using the above Solution S1 computations the corresponding horizontal depth distance from the viewing plane computed. For the computation of the angles the mechanism in FIG. 2 will need to be followed, either directly applying the FIG. 2 approach at each angle or taking the horizontal plane components and then considering the angles, depending on the Solution S1 approach chosen as outlined earlier in this (“Note”) paragraph.

Towards the cameras' speedily identifying the object portion computing pixel location from different angles towards the above computations, optimized, fast pattern recognition techniques would be used.

Each of the object portions would be comprised of numerous 3D computing pixels (i.e. corresponding to the 3D viewing pixels at the viewer's end). The color values of each of those depth coordinate computing pixels (i.e. computing pixels with 3D coordinates, with the two non-depth coordinates anyway directly known with reference to the relative distances parallel to the viewing plane) would be identified from camera data and stored for transmission. Refer Solution S4 for details on color representation at the viewer's end. If the count of chosen viewing angles at the viewer's end exceeds the count of video originating cameras at the corresponding directions, then the color data for a particular 3D viewing pixel location (that is consistently visible (i.e. not hidden behind any other entity) across that angle range from the cameras) at the viewer's end would be suitably interpolated from actual color data available from the cameras for that particular 3D location at the video stream generator's end. Note that as described elsewhere in this patent application if from any of the angles a computing pixel is invisible then color data for that angle for that computing pixel would simply be transmitted as color absorptive “black” and cannot (excepting by deliberate acceptance of level of approximation at the viewer's end) be included for color interpolation/extrapolation at the viewer's end.

### S2. Integrating 3D Coordinates On Same Object From Different Viewing Planes

Most of the computed depths determined in S1 will fall within the six viewing planes of an imaginary rectangular parallelepiped surrounding the primary imaging zone. Again, the actual count of viewing planes would typically at most be six (and optionally—atypically—greater than six), but would not necessarily be six all the time—depending on the choice by the video stream originator. Those computed depths therefore can be, to the extent deemed appropriate, minutely readjusted upon comparing with, if available, non-depth data and depth data as computed from the other viewing planes.

New depth data computed on other portions of the same object (and other portions of all other objects) as viewed from the other viewing planes are similarly fine tuned, to the extent appropriate and available, with non-depth- and depth data computed on data from the rest of the viewing planes. Some of the depth data will fall outside that rectangular parallelepiped. For example, when the video stream is outdoors then the sun, the sky, etc will always be outside the rectangular parallelepiped, yet visible from one or more viewing plane(s). Other near and far objects can by the video originator's choice fall outside the rectangular parallelepiped. So, for example, when available, the clearly visible “width” (i.e. non-depth) data from an adjacent (to a reference) viewing plane for a particular portion of an object could be compared to the computed depth data from that reference viewing plane for that same object portion. Similarly, if available, the depth data for an object portion as computed from two opposite viewing planes can be compared to fine tune the depth data.

Finally, all the 3D coordinate data (i.e. inclusive of depth data) for all object portions as viewed from all relevant viewing planes would simply be transmitted with the associated color data (Ref. S4) for mapping at the viewer's side in the corresponding proportional viewing rectangular parallelepiped (appropriately excluded/interpolated/extrapolated portions thereof to fit into the viewing box). It may be noted that the data would constitute actual representations of proportionally reduced (or in rare cases, when the actual objects are smaller than viewed in the viewing box, increased) coordinate values, where the color would remain the same (and optionally altered, at will, as a product feature) or interpolated (or in rare cases extrapolated). So essentially there would be a virtual representation of the actual location, so any count of people could simultaneously view it from any direction.

If the count of chosen viewing angles at the viewer's end exceeds the count of cameras at the corresponding directions, then the color data for a particular 3D viewing pixel location at the viewer's end would be computed as interpolations of actual color data available from the cameras for that particular object portion location at the video stream generator's end. That would be done excepting, as indicated at the end of the description of Solution S1, if from any of the angles a computing pixel is invisible, in which case color data for that angle for that computing pixel would simply be transmitted as color absorptive “black” and cannot (excepting by deliberate acceptance of level of approximation at the viewer's end) be included for color interpolation or extrapolation at the viewer's end.

Most objects seen around are opaque, so for displaying them a contour (i.e. the outermost non-ambiguous “tangible” surface) of the terrain would be visible—that essentially means that the 3D pixels in the “enclosed” space within the 3D contours would not be displayed, as in the real opaque world. For transparent and translucent objects, the 3D viewing pixels (i.e. corresponding to computing pixels) within the outer contours would be displayed through the layers of pixels surrounding them.

It is to be noted that most of the object portions cannot be viewed from simultaneous multiple viewing planes and therefore depth computation integration for the same object portions as viewed from multiple viewing planes would for most computing pixels not be applicable.

### S3. Speedy Computations

To enable real time transmission and display, the computations would be optimized (in addition of course to providing sufficient computing resources) to speed up.

This would be done by a combination of both the following
A. Using optimized, simplified computations for the algorithms
B. Using an array of microprocessors (including computers to the extent necessary) to distribute the computing load

Among the computations efficiency mechanisms would be, but not limited to
1. Using chip hardware based computation optimization techniques to maximize the speed of computation of tangent and division. These techniques include assembly instruction pipelining for the maximum parallelism, interleaving instructions of appropriate differing categories for the maximum use of the chip's computing units and minimize instruction waits, maximally representing computations in terms of addition and/or subtraction and/or multiplication (primarily addition and/or subtraction) and minimizing divisions (and the effect of that would separately in part be augmented by referring pre-computed coefficient tables for the calculation of tangent), optimizing the use of the chip's computing units, designing fast hardware adders, etc.
2. Optimizing the computing algorithm by trigonometric function angle range reduction, optionally representing the computations in Solution S1 in terms of trigonometric sine and trigonometric cosine rather than in terms of trigonometric tangent in a manner that the overall computation cycles are reduced, table lookup with pre-calculated tangent values for a reasonable (per the application) precision of the input angle range—that would be a considerably effective speed up method.
3. Table lookup for entire pre-calculated values of the coefficient (i.e. tan(β)/{1−tan(β)/tan(α)}) of “d” for depth computation from Solution S1 would be an important additional speedup option. For 99.9% of applications extreme precisions of input angles α and β would NOT be necessary. Therefore, within that degree of precision—which, per the application, could typically range from (say) 2 decimal digits to 4 or 6 decimal digits (or, in extremely rare cases higher counts of decimal digits)—the full depth coefficient values would be pre-computed and stored. Then for each object portion computing pixel location the depth would be directly computed by just multiplying with the coefficient from the lookup table based on the input angles.
4. Towards speedy pattern recognition (to identify and select a computing pixel and then for the computation of the corresponding angles α and β) the techniques to be used would include, but not be limited to, gray scale analysis, optimized identification of fundamental pattern combination in video image frame, etc.

### S4. The Viewing Box

A convenient display option would be by way of projecting light in a transparent gas or in a transparent rigid non-fluid medium in the enclosed space of the viewing box. The basic principle would be to project focused micro-beams of light of different frequencies (i.e. wavelengths) (and, to the appropriate extent, intensities) from two directions such that they interfere at a specific spatial coordinate to yield a specific new frequency (i.e. wavelength) of light at that point at which the material within the viewing box would glow for a micro time period at a particular color. Various material options are possible. So to have a continuous display of a viewing “pixel” within the spatial coordinates of the viewing box it will need to be refreshed at a frequency higher than the minimum required for persistence of vision and beamed for the duration of vision sought for that viewing pixel.

Accordingly, a mechanism being claimed in this patent application is projecting multiple individually invisible (i.e. outside the visible range of the approximately 380-750 nm wavelength) micro-thin beams of light in a vacuum, at the necessary wavelengths, pulse durations and intensities such that they together interfere at the points of interference to produce visible light of the desired wavelengths (hence colors). To enable/enhance visibility from a solid angle range of each such point of interference, each of those minimum sets of micro-thin beams of invisible light (that are necessary, upon constructively and/or destructively interfering, to produce a spatial viewing pixel of light of the chosen color visible from one direction) would need to be simultaneously beamed in (for that same spatial 3D coordinate of interference) from a solid angle range (or sequentially beamed in over that solid angle range, at a rate higher than that necessary for persistence of vision from all directions in that solid angle range) for viewing in the chosen corresponding solid angle range. That solid angle would be corresponding to the chosen direction “resolution” for display—i.e. how many different directions can each object (in terms of the corresponding visible object portions) be seen from? It is again to be noted that that resolution is independent of the count of physical cameras at the video stream generator's end. Each of those directions, hence the solid angle corresponding to it, would interpolate to one image micro-portion that can be seen from all points in that angle, hence the colors in each viewing pixel in that micro-portion need be visible from all points in that solid angle.

An alternative claim in this patent application on a mechanism of multidirectional visibility, without needing the abovementioned same minimum sets of micro-thin light beams simultaneously (or high speed sequentially) projected from across a range of solid angles, would be to use a rigid, static, transparent medium of micro crystals and/or equivalents (including but not limited to nanotubes) that would reflect each point of light in a solid angle “window”, with that angle being controlled by either the physical directions of the embedded crystals/equivalents or the angles of the constituent fibers in each such embedded crystal/equivalent, embedded corresponding to the angle of chosen extent of directional “resolution” (i.e. for the corresponding solid angle). As above, that solid angle would be corresponding to the chosen direction “resolution” for display—i.e. how many different directions can each object (in terms of the corresponding visible object portions) be seen from?

A form of rigid multi-faced TFT (thin film transistor) based transparent hardware device pixels (several of which together would constitute a viewing pixel) would be another option. Typically these viewing pixels will each have 6 faces, but for a greater color manifestation—at the expense of an increased data bandwidth—the count can be increased. The display medium comprising of those multi-dimensional viewing pixels would be made up of multiple lavers of transparent semiconductor TFT LCD display sheets that would use transparent Indium Tin Oxide (ITO) electrodes or optionally carbon nanotubes; aluminum doped zinc oxide, etc—this patent application does not claim intellectual property rights on any of the currently in use renditions of TFT displays and on their respective chemical compositions and physical structures. Because of the combined thickness of the sheets, the need to ensure the maximum transparency of each TFT display layer is high, hence the use of material based on ITO, etc. Some more transparent semiconductor options are already available in the world today whose intellectual property rights are not claimed in this patent application to the extent (and not otherwise) they are already patented by others, including and not limited to of those (transparent semiconductors) formed by exposing the semiconductor crystals to high energy particulate radiation to augment transparency, the use of transparent semiconductor-polymer hybrids, organic thin film semiconductors, indium gallium zinc oxide based transparent semiconductors, and more. A suitable color filter material would be used to maximize the transparency of each 3D hardware pixel layer. The LCD hardware pixel unit will also be trans-reflective when so chosen—i.e. reflect most of the incident light—therefore minimizing or eliminating the need for a micro-backlight unit. The refractive indices of the constituent material of each hardware pixel layer (inclusive of the electrodes, polarizer sheets, etc) would be chosen to minimize or for all practical purposes eliminate differential refraction. An important aspect of each hardware pixel unit would be its ability to render itself up to (i.e. not necessarily only) completely opaque (i.e. the degree of opacity being reflective of the corresponding object portion computing pixel's opacity) while being part of an active display pixel in a video image frame so that unnatural semi-transparency is not manifested for objects that are opaque. That property can be easily manifested by optionally having a second liquid crystal layer on each hardware pixel that can be realigned with transparent electrodes to effectively polarize itself (in interaction with existing or a separate polarizing layer to the extent necessary) to the appropriate opacity. As one or up to all of each of the (6 or more) faces of the hardware pixel could need to be rendered opaque depending on the video steam image frame, the design can easily be rendered to allow for that while not necessarily adding an extra LCD layer (optionally associated by extra electrodes and/or polarizers) on each side—essentially LCD duality need be enabled such that the same liquid crystal layer could at one side display color (reflective and/or emitting with/without a localized backlight) while the other size is realigned for opacity. Rights to the contents in this paragraph are claimed in this patent application to the extent of (but not limited to) the multi layered structuring appropriate to the rest of this patent application—what is not claimed (only to the extent that they are already patented, and not otherwise) are the rights to the chemical compositions listed in this paragraph, and the generic, already established properties of TFT and allied LCD screens.

FIG. 3 depicts a few examples of various viewing box structures, all compatible to data stream from the same video stream generator, because proportional data outside a viewing box's space would simply be excluded, or the entire data proportionally compressed/expanded to any chosen extent to entirely fit within any viewing box.

Everything mentioned in this section in the context of a 3D video image frame generally applies to a static 3D photo frame too hence the latter has not been separately discussed in elaboration.

FIG. 4 depicts an example of camera setup.

FIG. 5 presents an example of the operation of the invention.

All, and only all and no more, and no less, among those that have been discussed in this subsection (“Technical details”) that are not already, patented and are patentable are claimed the rights to in this patent application.

### Proof of Feasibility, Tangibility And Concreteness

The proof of feasibility is self evident from the specifications.

The proof of tangibility is in the very significant non-virtual 3D video generation capabilities achieved with the product's specifications.

The proof of concreteness is in the unambiguous specifics.

### Special Advantages of Invention

Among the special advantages of the product are—
1. The sending video stream volumes can be generated by cameras in any viewing plane configuration and viewed at the receiver's end in any viewing box shape/structure—including but not limited to rectangular parallelepiped, cylindrical, spherical, hemispherical, conical or absolutely any other shape.
2. While the key application of this invention is intended to be as a consumer electronics utility, the invention is relevant to ANY application domain where a 3D video image is useful—e.g. in medical, aerospace, manufacturing, various forms of high technology research and development, safety and security engineering (for buildings, mines, bridges, and any other large or small entity of use by people), construction, etc.

### Fair Scope of Invention

All, and only all and no more, and no less, among those that have been discussed in this patent application as being included in the scope of this patent application are intended to include only those among them that are lawfully patentable and do not infringe on any other inventor's/applicant's/entity's lawful intellectual property rights.

### DESCRIPTIVE LEGENDS ON FIGURES

FIG. 1

Top view of an example scenario with two cameras and an object portion in the same horizontal plane

A—Location of computing pixel on portion of object visible from viewing plane (whose vertical projection section is BD)

B—The point where the distance from A to the viewing plane is the shortest

C—Location of Camera 1 on the viewing place

D—Location of Camera 2 on the viewing plane

α, β—Angles to A with respect to the locations of Camera 1 and Camera 2

d—Horizontal distance between the two cameras

y—Horizontal shortest distance of Camera 1 to line AB

Note—For algorithm explanation with this figure, points A, B, C and D are all in the same horizontal plane. However, they don't have to be, per this invention, and the computations can be adjusted accordingly. Those alternative configuration and computation particulars are all included in the scope of this invention only to the extent they constitute part of the complete invention, and are not included in the scope of this invention by themselves alone.

FIG. 2

Example mechanism of determining “α” (and “β”)

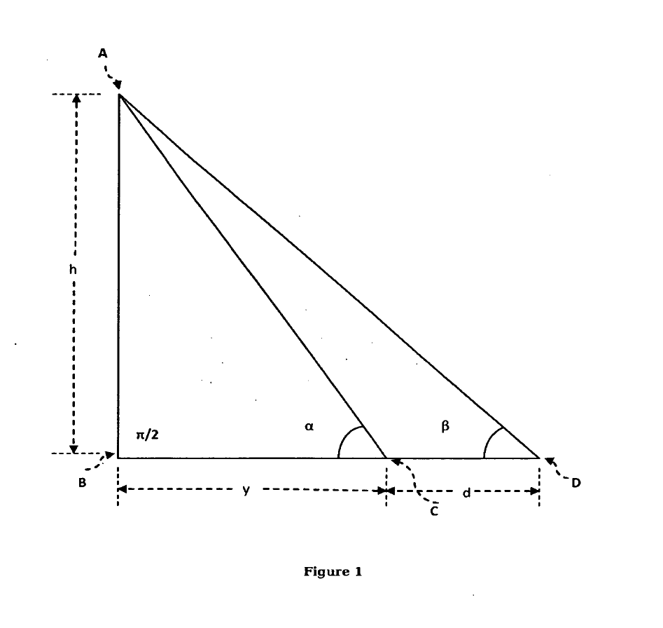

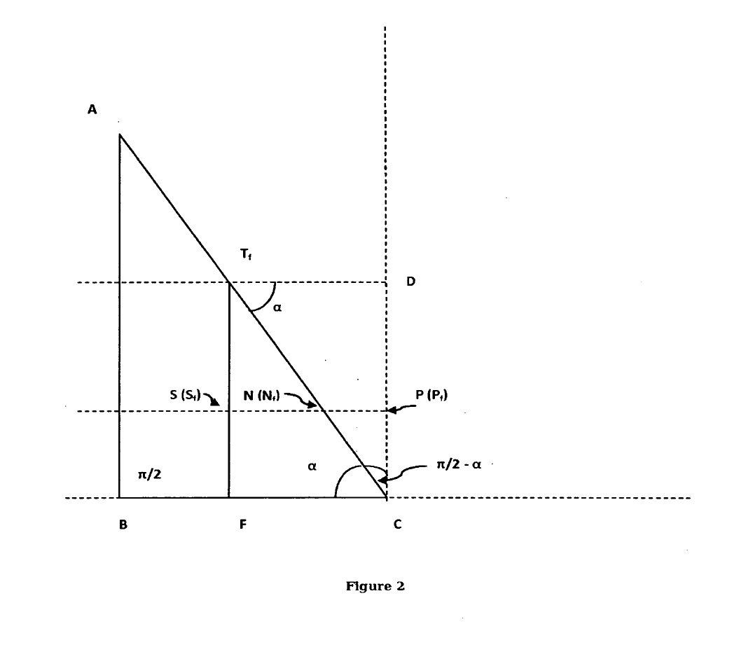

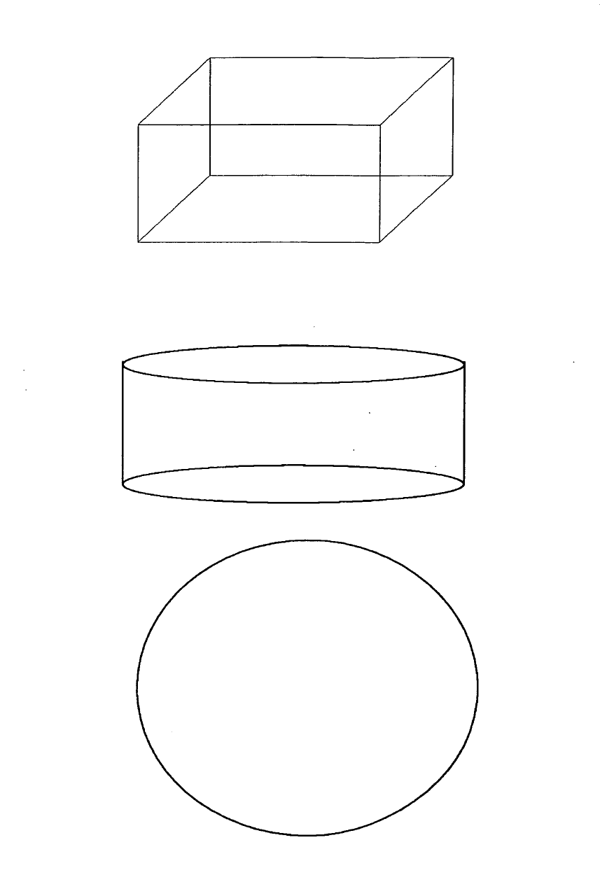

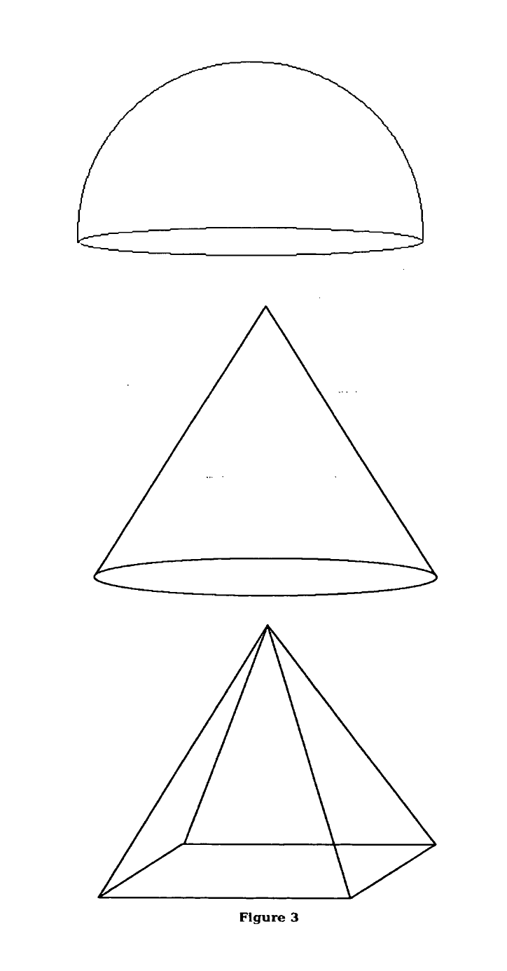

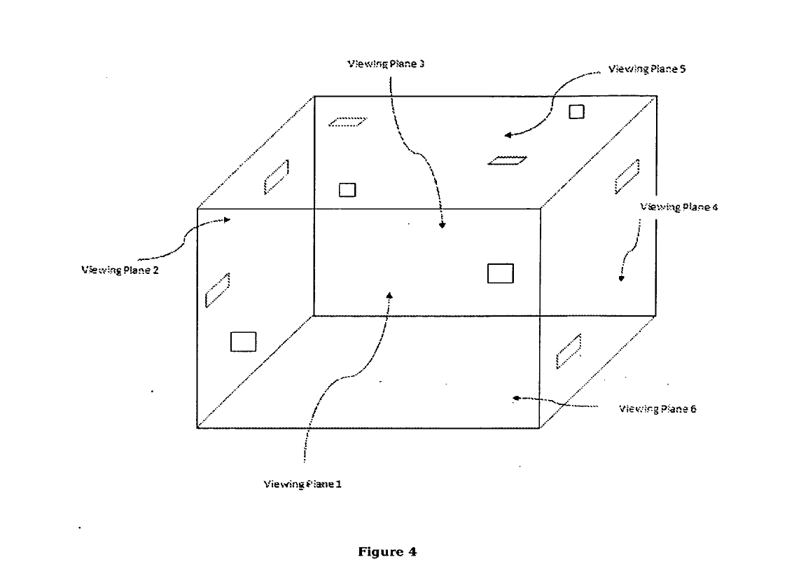

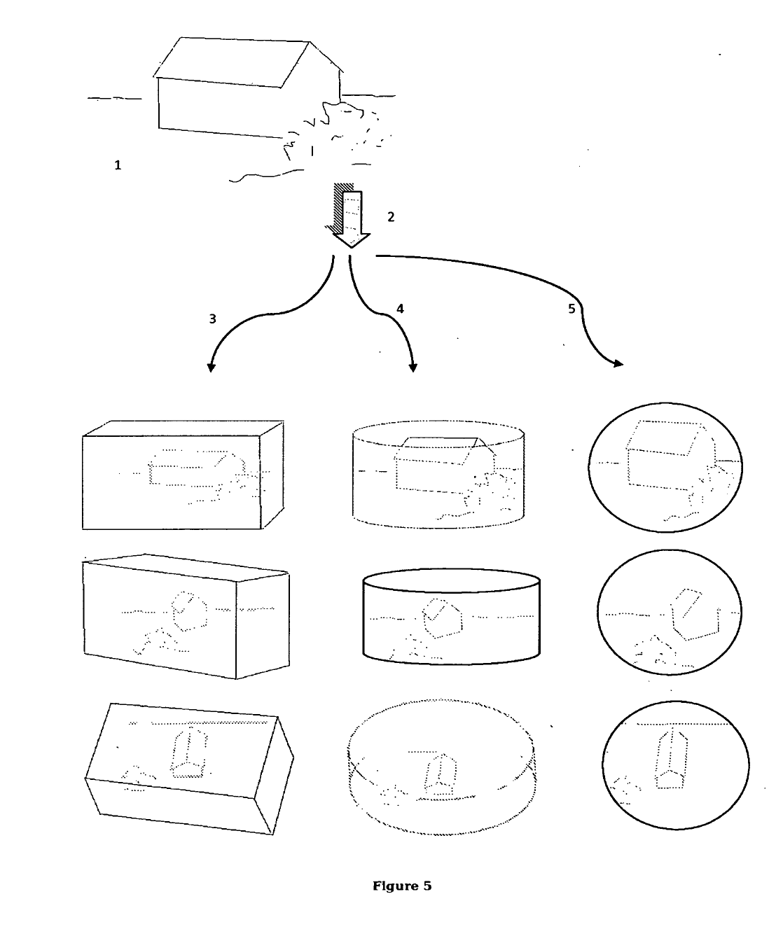

(Refer to FIG. 1)

A—Actual remote location of the object portion computing pixel

C—Actual location of Camera 1

SP—Horizontal line parallel to viewing plane at a known distance from Camera 1, whose image (S_{f}P_{f}) in video image/photo frame will be the reference line for angle calibrations from data in that video image/photo frame; in effect S_{f}P_{f} could be a calibration reference line directly embedded in the camera internals without necessarily requiring the actual real life physical points S and P.

T_{f}—Map of object portion location viewing pixel A in video image/photo frame as seen from Camera 1.

N—Map of T_{f} (and hence of the object portion computing pixel location A) on reference line SP. Hence N_{f} is the map of T_{f} (and of the object portion location A) on reference line S_{f}P_{f} in image frame.

FIG. 5

An example of the operation of the NON-VIRTUAL-3D VIDEO/PHOTO GENERATOR

1—Original real location

2—Transmission for non-virtual-3D viewing at remote location

3—Transmitted video/photo viewed at remote location inside non-virtual-3D-RECTANGULAR PARALLELEPIPED television #1, as seen from 3 angles

4—Transmitted video/photo viewed at remote location inside non-virtual-3D-CYLINDRICAL television #2, as seen from 3 angles

5—Transmitted video/photo viewed at remote location inside non-virtual-3D-SPHERICAL television #3, as seen from 3 angles

The non-virtual-3D televisions can be of any shape and size appropriate to the market segment—e.g. they can be micro- or mini sized and shaped for portable use, regular sized and shaped for use in homes and businesses, large sized and suitably shaped for business conferences and industries or giant sized and appropriately shaped for massive public gatherings.

### Legal

Any and all item(s) that might be listed in this patent application, on which intellectual property right(s) (including, but not limited to, patent(s), trademark(s), service mark(s), copyright(s), etc.) is/are currently already owned by, and/or by other than, this inventor/applicant (and/or by any future assignee(s) on this invention) is/are just that—its/their current intellectual property ownership is as currently listed in the appropriate lawful official database(s) on such intellectual property ownership. If any sub-component(s) of the plurality of aspects of the claim(s) of this invention is/are (then, or otherwise) already patented (that latter is or would be valid (i.e. not expired, withdrawn, etc)) by other than this inventor/applicant (and/or any future assignee(s) on this invention) then the scope of the claim(s) of this invention only when such sub-component(s) is/are actually applied (i.e. used) per such claim(s) would be, in lawful reasonableness, as new use and/or improvement use.

What is claimed is:

1. A prophetic unified invention that replicates real life object(s) as non-virtual-3D video(s) and/or non-virtual-3D photo(s) in the sense that the 3D video(s) and/or 3D photo(s) would be generated to be viewed with effectively the same 3D realism from all simultaneous directions as the original real life object(s); Unlike what is usually done for 3D imaging in the world today, the non-virtual-3D video(s) and/or non-virtual-3D photo(s) generated by this invention would not be displayed on a flat screen (or on/in other display mediums where the video(s)/photo(s) could at best be artificially—i.e. virtually—made to appear 3D when viewed from certain angles only); Instead, the non-virtual-3D video(s) and/or non-virtual-3D photo(s) would be displayed in a medium that physically has actual proportionate depth, enabling the NON-VIRTUAL-3D VIDEO(S) AND/OR NON-VIRTUAL-3D PHOTO(S) to be DISPLAYED WITH ACTUAL PHYSICAL DEPTH of any chosen size, such that, exactly as with the original real life object(s) at the original real life location(s), any count of multiple viewers in physical proximity to the non-virtual-3D display medium would be able to simultaneously view the generated non-virtual-3D video(s) and/or non-virtual-3D photo(s) from all those multiple viewers' respective different viewing angle(s) relative to the displayed object(s) in the non-virtual-3D video(s) and/or non-virtual-3D photo(s), exactly as those multiple viewers would see the original real object(s) if the viewers stood at the original real life location(s); THE VIEWERS WOULD BE ABLE TO PHYSICALLY WALK AROUND OR OVER OR UNDER THE DISPLAYED NON-VIRTUAL-3D VIDEO(s) AND/OR NON-VIRTUAL-3D PHOTO(s) SUCH THAT THE DISPLAYED OBJECT(s) IN THE NON-VIRTUAL-3D VIDEO(s) AND/OR NON-VIRTUAL-3D PHOTO(s) WOULD BE SIMULTANEOUSLY AND REALISTICALLY VISIBLE TO ALL THOSE VIEWERS AT THE EXACT DIFFERENT CHANGING ANGLES AS IF THE VIEWERS WERE MOVING ABOUT AROUND THE REAL LIFE LOCATION(s);
The invention comprises of the following two core components—
A. A viewing box (i.e. non-virtual-3D television) displaying static non-virtual-3D image(s) (non-virtual-3D photo(s)) and/or non-virtual-3D video(s) whose (i.e. viewing box's) plurality of features would comprise of the following:
(i). The viewing box (i.e. non-virtual-3D television) could be of any non-virtual-3D size and any non-virtual-3D shape appropriate to the market or otherwise (appropriate to) the application (each unit's size and/or shape could be fixed or variable)—for example (but not limited to this example), the viewing box (i.e. non-virtual-3D television) could be micro- or mini sized and shaped for portable use, regular sized and shaped for use in homes and businesses, large sized and suitably shaped for business conferences and industries or giant sized and appropriately shaped for massive public gatherings, etc;
(ii). Objects in the static non-virtual-3D image(s) (non-virtual-3D photo(s)) and/or non-virtual-3D video(s) content displayed inside the viewing box (i.e. non-virtual-3D television) would be exactly proportional in all three (3) dimensions to the corresponding real life object(s) being displayed (unless in some viewing box (i.e. non-virtual-3D television) models the proportion is allowed to be deliberately altered (i.e. distorted) from real life proportions);
(iii). The contents displayed inside the viewing box (i.e. non-virtual-3D television) could be simultaneously viewed from as many different directions as the viewing box (i.e. non-virtual-3D television) model is elected to be designed for—in other words while the technology of this invention would permit simultaneous viewing from up to all directions the viewing box (i.e. non-virtual-3D television) models don't all have to have viewing “windows” (or equivalents) in all directions if the applications of such viewing box (i.e. non-virtual-3D television) models don't necessitate such.
(iv). The essential non-virtual-3D display technology of the viewing box (i.e. non-virtual-3D television) at the viewer's (/viewers') end would comprise of (i.e. include but not be limited to) one or both of the following depending on the viewing box (i.e. non-virtual-3D television) model—
(a) enabling a count of simultaneous (and/or high speed sequential) thin light beams (and, on reasonable extension, in some cases accompanied by one/more other form(s) of “supporting”/“fine tuning” electromagnetic wave(s)) of frequencies in the invisible (and/or, on reasonable extension, in some cases in differently visible) frequency range(s) to together constructively and/or destructively interfere to generate point(s) of light in the visible frequency range of chosen directional color(s) (either at or/and very-near-“around” each chosen non-virtual-3D coordinate inside the viewing box (i.e. non-virtual-3D television) corresponding to the directional color(s) visible at the corresponding 3D coordinate of the actual real life location) (Note: the aforesaid multidirectional interference would be sequentially timed and/or spatially focused such that different colors will be visible from different directions for the same non-virtual-3D coordinate corresponding to the different colors seen from different directions for the original 3D coordinate in the real life location, with the directionally different colors for the same non-virtual-3D coordinate being produced inside the viewing box (i.e. non-virtual-3D television) by different groups of thin light beams from different directions either high-speed-sequentially (at a frequency equal to or higher than that necessary for persistence of vision) interfering precisely at the same non-virtual-3D coordinate or by simultaneously interfering at slightly different points very close “around” surrounding (but not precisely at) that non-virtual-3D coordinate (thereby in the latter option leading to those points of colors (visible from those corresponding different directions) very close “around” surrounding (but not precisely at) that non-virtual-3D coordinate));
This form of interference is technologically based on the principle of enabling scalar/vector periodic functions (noting that light waves, for many practical purposes, are periodic functions) to be represented as a function of up to an indefinite count of other periodic AND/OR non-periodic scalar and/or vector functions—i.e., for example, a time dependent periodic vector/scalar function F_{R(p(t))}(t) could be represented as
F_{R(p(t))}(t)=T₁(F₁₍ₚ₍ₜ₎₎(t), F₂₍ₚ₍ₜ₎₎(t), F₃₍ₚ₍ₜ₎₎(t), . . . , Fₙ₍ₚ₍ₜ₎₎(t))
where “t” denotes the variable time and the subscript part “(p(t))” is intended to denote that the corresponding function is periodic in time, and F_{R} is the resultant periodic vector/scalar function, while F₁, F₂, F₃, . . . Fₙ, are the other vector/scalar periodic (in time) functions that interact together as the constituents of function T, to generate that resultant vector/scalar function periodic (in time) F_{R}, and “n” could be an integer as high or as low (>0) as the aforementioned combination of the resultant and constituent periodic (in time) vector/scalar functions require in different scenarios; Generalizing the above equation further
F_{R(p(t))}(t)=T₂(F₁₍ₚ₍ₜ₎₎(t), F₂₍ₚ₍ₜ₎₎(t), F₃₍ₚ₍ₜ₎₎(t), . . . , Fₙ₍ₚ₍ₜ₎₎(t), C₁₍ₙₚ₍ₜ₎₎(t), C₂₍ₙₚ₍ₜ₎₎(t), C₃₍ₙₚ₍ₜ₎₎(t), . . . , Cₘ₍ₙₚ₍ₜ₎₎(t))
where the subscript part “(np(t))” is intended to denote in the above equation that the corresponding function is non-periodic in time, such that the resultant vector/scalar periodic (in time) function is formed using an appropriate function T₂( )of a set of vector/scalar periodic (in time) and non-periodic (in time) functions, where the value of the integers “m” and “n” could range from 1 to as high or as low (>0) as is required per the set of the resultant vector/scalar periodic (in time) function and constituent vector/scalar periodic (in time) and/or non-periodic (in time) functions in different scenarios; Often, and most definitely not always, such periodic (in time) functions representing light (and allied electromagnetic waves) would be sine( )and/or cosine( ) Often, and most definitely not always, when non-periodic (in time) functions either by themselves or in combination with periodic (in time) functions generate a resultant periodic (in time) function, it would be preferred that some/all of the non-periodic (in time) functions be suitably repeated in varying or regular periodic (in time (or/and frequency, or/and other parameter(s)) patterns—however, as indicated above, such repetitions (of non-periodic (in time) functions) are not mandatory to generate an aforementioned resultant periodic (in time) function;
(b) Transparent (to appropriate extents) and translucent directional crystals (or equivalents (including but not limited to nanotubes)), fibers, LCD entities, et al would be used as the material(s) of the display medium to allow light at chosen colors to be displayed in a wide range of specific, narrow directions relative to each relevant non-virtual-3D coordinate inside the viewing box (i.e. non-virtual-3D television) corresponding to the color(s) visible in those same wide range of relative, narrow directions at the corresponding 3D coordinate of the actual real life location—such transparency and translucency of the material(s) of the display medium is necessary because the original real life object(s) might be transparent/translucent; the transparency/translucency of such material(s) of the display medium should be such that the same, unchanged material(s) of the display medium should also be able to render themselves entirely opaque (for when the real life objects are opaque);
B. A 3D data capture and processing system at the end of the originator of the static non-virtual-3D image(s) (non-virtual-3D photo(s)) and/or non-virtual-3D video(s), that would, depending on the product's model, essentially comprise of (i.e. include but not be limited to) variations of one, some or all of the following plurality of features—
(a) The system would determine the actual depth of each visible real life 3D coordinate as an easily computable mathematical function (i.e. mathematical function not demanding too much computation load on the processor(s), hence minimizing any possibility of adversely compromising real time transmission of display data to the remote viewing box (i.e. non-virtual-3D television)) of primarily (but not necessarily limited to) merely the physical distance between two (or more) cameras simultaneously seeing that real life 3D coordinate and the physical angles at which those cameras see that real life 3D coordinate, as represented by the following fundamental equation for two cameras and/or by all its reasonable variants (whereby such variants might be related or/and even entirely unrelated to the aforementioned following fundamental equation)—
h=d*tan(β)/{1−tan(β)/tan(α)}.
where “d” is the physical distance between the two cameras and “α” & “β” are the angles at which those two cameras see that particular real life 3D coordinate; the angles “α” and “β” would be easily computed (i.e. not requiring much computation load on the processor(s) hence minimizing any possibility of adversely compromising real time display data transmission) by noting the (and/or by all its reasonable (related or unrelated) variants) projection of the real life 3D coordinate on a preexisting calibrated reference line/frame on the camera viewfinder's (or appropriate equivalent's) display;
(b) The system would fine tune color and 3D coordinate data determined for an appropriate selection of the visible real life 3D points (i.e. not necessarily all visible real life 3D points, since, but not limited to, they would not all be simultaneously visible from multiple viewing planes) by integrating real life 3D coordinate value and color data from two or more viewing planes;
(c) The system would enable efficient computation techniques to minimize any possibility of adversely compromising real time transmission of display data to the remote viewing box (i.e. non-virtual-3D television) that (computation techniques) would comprise of (i.e. include but not be limited to)—
i. Effecting processor (including its accessories') hardware based computation optimization techniques aimed at the consumption of the minimum computing cycles; such techniques might include but not be limited to assembly instruction pipelining, interleaving (appropriate to the hardware components to maximize their use) categories of instructions;
ii. Representing the necessary mathematical functions in a form that would consume a relatively lower count of computing cycles regardless of hardware (for example, but not limited to these examples, [ii.1] computing sine or cosine often Lakes a lower count of computing cycles than would computing the tangent, therefore representing the tangent in terms of the sine and/or the cosine wherever the aggregate count of computing cycles could be appropriately reduced that way, [ii.2] the division operation often takes more computing cycles than addition and subtraction and even multiplication, therefore replacing the division operation by an appropriate combination of addition and/or subtraction and/or multiplication (primarily addition and/or subtraction));
iii. Maximally using direct data table lookup for most ranges of angles (or/and other relevant variables) for trigonometric (or/and other) computations, instead of undertaking such computations afresh always; such data table lookup could include but not be limited to, for example, towards directly determining (without actually computing) the entire value of the coefficient of “d” in the equation for “h” in B(a) (i.e. the value of the expression tan(β)/{1−tan(β)/tan(α)}) for meaningful combinations of ranges of values of the angles “α” and “β”—that should very significantly speed up processing;
iv. Enabling efficient pattern recognition techniques towards a speedier identification of real life 3D points (to compute angles “α” and “β” and therefore the depth “h” for such real life 3D points);
Note #1
The viewing box (i.e. non-virtual-3D television) of “A.” of this claim is the most significant component of, hence the core identifying signature of, this invention and hence of this claim; Hence all reasonable morphs/variations/renditions/forms/flavors of “A.” by itself even without at all being accompanied by “B” is in the scope of this claim;
Note #2
Combinations of all reasonable morphs/variations/renditions/Forms/flavors of “A.” and “B.” together, applied towards this claim along lines reasonably similar (even when not exactly identical) to as defined from the beginning of this claim up to preceding Note #1, are also within the scope of this claim;
Note #3
If any sub-component(s) of the plurality of aspects of “A.” or/and “B.” of this claim is/are (then, or otherwise) already patented (that latter is or would be valid (i.e. not expired, withdrawn, etc)) by other than this inventor/applicant (and/or any future assignee(s) on this invention) then the scope of this claim only when such sub-component(s) is/are actually applied (i.e. used) per this claim would be, in lawful reasonableness, as new use and/or improvement use;
Note #4
Because, in actual effect, including but not limited to in as much as the lawful scope of this invention (and hence of this claim), nothing substantively new has been added to these claims and to the specifications of the invention in this patent application than were already expressly or reasonably implicitly included in the original patent application (PCT International Application No. PCT/IB2009/052404 filed with RO/IB on 7 Jun. 2009) and in the latter's priority document (USPTO Provisional Patent Application No. 61061108 filed on 12 Jun. 2008), this patent application is lawfully no less eligible to be processed either as a national phase PCT application or as a continuation (or equivalent) application than as a continuation-in-part (or equivalent) application, appropriate to the laws of the respective nations.
